(19) United States
(12) Patent Application Publication
(10) Pub. No.: US 2008/0052181 A1
(43) Pub. Date: Feb. 28, 2008

(54) Integrated system for providing user services

(76) Inventors: Taram Devitt-Carolan, San Jose, CA (US); Ayman W. Habib, San Jose, CA (US); Moenes Iskarous, San Jose, CA (US); Anthony Magliulo, Fremont, CA (US); Sameh Michaiel, San Jose, CA (US)

Correspondence Address: Sameh Michaiel, 4229 Littleworth Way, San Jose, CA, 95135, US

(21) Appl. No.: 11/507,987

(22) Filed: Aug. 23, 2006

(51) Int. Cl. G06Q 30/00

(52) U.S. Cl. 705/26

(57) ABSTRACT

Active forms are intended to replace paper forms to increase the efficiency of workflow within an organization. In addition to replacing paper forms, the basic nature of active forms makes them well suited for use in systems that encompass multiple organizations. The invention consists of improved methods and systems using active forms, particularly among multiple organizations and with mobile computing devices.

### FIELD OF THE INVENTION

The present invention relates generally to communication and processing of active forms and other types of electronic documents.

### BACKGROUND OF THE INVENTION

Businesses traditionally use paper forms for many different purposes. Paper forms have proved useful, but they suffer from several drawbacks. The main drawback is that paper forms are not well-suited to computerization. If forms are stored in a computer, they usually are scanned and stored as an image for archival purposes. Unfortunately, a document stored as an image requires more storage space than a document stored using a non-image format, such as HTML. Also, it is difficult for a computer to find specific information unless the scanned documents are processed using optical character recognition. Even if optical character recognition is performed, a significant number of errors may be introduced during optical character recognition.

Active forms, a type of active document, were developed to overcome the problems of conventional paper forms and forms stored as images. A typical example of an active form is an Adobe™ PDF fill-in form. Although Adobe™ PDF fill-in forms are a well-known type of active form, our use of the phrase “active form” is generic and applies to a wide variety of existing and potential active forms.

Active forms, like paper forms, contain two types of content: Information that comprises the form that is not intended to be altered and user-changeable information called fields. Typically fields contain null values initially and the user changes the values as needed. Using business rules, active forms can ensure that fields are filled out correctly. For example, a certain field might accept only digits instead of arbitrary characters.

Active forms usually are stored on a server and can be downloaded to a client computing device or workstation when needed. The active forms themselves usually operate independently when on a computer. Active forms can interact with users and forms-based processes, such as insurance, payroll and benefits programs and they can be populated with user information from back-end systems. After an interaction, they can trigger a workflow that routes them to the appropriate individuals and updates pertinent databases.

FIG. 1 shows a typical infrastructure for active forms, with a user 100, a client computing device 200 and a server module 300. The client computing device 200 and the server module 300 are connected by a communication link 400. A client computing device could be a variety of things, such as a personal computer, a cellular telephone or a personal digital assistant. We use the term “server module” rather than “server computer” because more than one module may reside on a single physical computer.

Active forms are moved under manual control between a server module and a client computing device as shown in FIG. 2. Typically, the server module 300 receives an active form request 105 from client computing device 200. The server module 300 responds by sending an uncompleted or partially populated active form 205 to client computing device 200. The user 100 uses client computing device 200 to complete the active form. When the user 100 has completed the active form, he tells client computing device 200 to send the user-modified active form 305 to server module 300.

FIG. 3 is another way to view the same sequence as just described. An active form operation begins at step 1000 when the user indicates his desire for an active form. The client computing device requests an active form from the server module in step 1100. The server module then sends the requested active form to the client computing device in step 1200. The user modifies fields of the active form using the client computing device in step 1300. When the user is finished modifying the active form, the modified active form is sent from the client computing device to the server module in step 1400.

An advantage of active forms is that they can be modified on a client computing device even if no communication link is available. Contrast this with filling out a form on a web page: in this case, the form is completed by sending information over a communication link in real time to add information to the form, rather than sending an already completed form. Active forms are an asynchronous method of moving information, because an arbitrary amount of time can pass between actions in a workflow incorporating active forms.

A communication link is needed to move active forms from one computer to another. A communication link may be implemented using any method of moving data from one computer to another. Some examples of communication links include local area networks, infrared links, wireless links. Email also may be used as a communication link to move active forms from one computer to another. The asynchronous nature of active forms allows the use of communication links that cannot be used with web-based systems. For example, the “communication link” for moving active forms from a server to a client computing device could involve sending a CD ROM containing active forms through the mail.

Unlike forms on a web page, active forms are better suited for use in mobile environments in which a communication link may not always be available because active forms can be modified by the user even when no communication link is available.

### SUMMARY OF THE PRESENT INVENTION

An object of the invention is to provide a flexible methods and system for the communication and processing of active forms. Another object of the invention is to provide methods to use active forms among multiple organizations. Another objective of the invention is to allow a single active form to be completed jointly by multiple people. Another object of the invention is to simplify the use of active forms on mobile computers. Another object of the invention is to improve the transmission and storage efficiency of active forms. Another object of the invention is to provide a method of populating an active form using multiple databases on multiple computers in different organizations. Another object of the invention is to use active forms to modify databases on computers other than on the computer that performs the conventional active form processing.

### BRIEF DESCRIPTION OF THE FIGURES

These and other features and advantages of the invention will be more readily understood from the following detailed description of the invention which is provided in connection with the accompanying drawings, in which:

FIG. 1 shows a typical infrastructure that supports the use of active forms.

FIG. 2 shows a typical interaction among entities when using an active form.

FIG. 3 shows a typical method of using an active form.

FIG. 4 shows a multi-organization infrastructure that supports the use of active forms.

FIG. 5 shows the user request phase of an active form transaction.

FIG. 6 shows the intermediate request phase of an active form transaction.

FIG. 7 shows the provider response phase of an active form transaction.

FIG. 8 shows the provider response phase of an active form transaction.

FIG. 9 shows a method of constructing a new active form from multiple existing active forms.

FIG. 10 shows the provider response phase of an active form transaction.

FIG. 11 shows a method that allows multiple users to complete an active form jointly.

FIG. 12 shows a method for sending a completed active form when a communication channel is available.

FIG. 13 shows a method for efficient exchange of active form data.

FIG. 14 shows a method for efficient exchange of active form data.

FIG. 15 shows a method for efficient exchange of active form data.

FIG. 16 shows a method for efficient exchange of active form data.

FIG. 17 shows a method for efficient exchange of active form data.

FIG. 18 shows a method for efficient exchange of active form data.

FIG. 19 shows a method of pre-populating active form fields.

FIG. 20 shows a method of post-populating active form fields.

FIG. 21 shows a method of updating a database using active forms.

### DETAILED DESCRIPTION

### Intelligent Transport of Active Forms Among Multiple Complementary Organizations

In the following detailed description, reference is made to the accompanying drawings, which form a part hereof, and in which is shown by way of illustration specific embodiments in which the invention may be practiced. These embodiments are described in sufficient detail to enable those of ordinary skill in the art to make and use the invention, and it is to be understood that structural, logical, or procedural changes may be made to the specific embodiments disclosed without departing from the sprit and scope of the present invention. References to “an” or “one” embodiment in this disclosure are not necessarily to the same embodiment, and such references mean at least one.

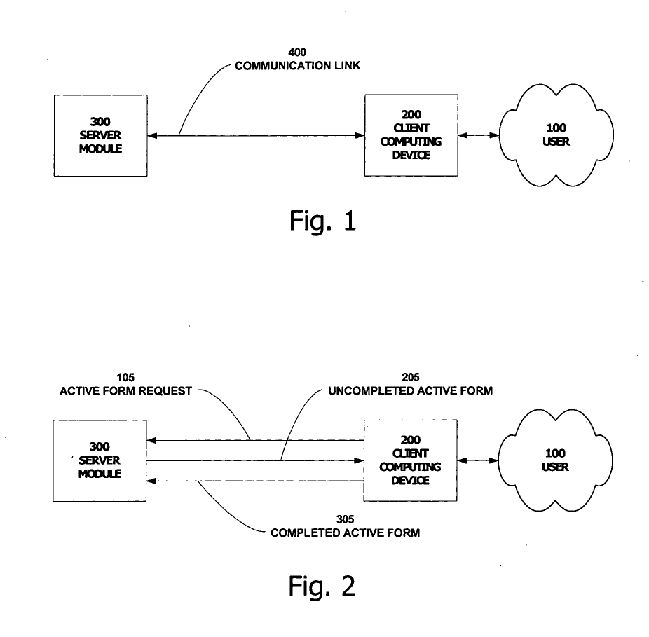

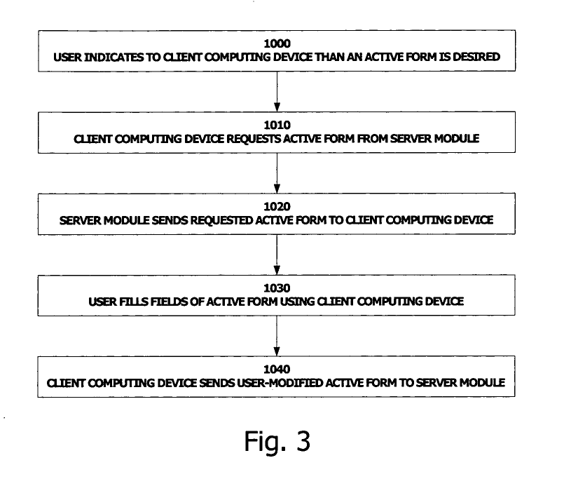

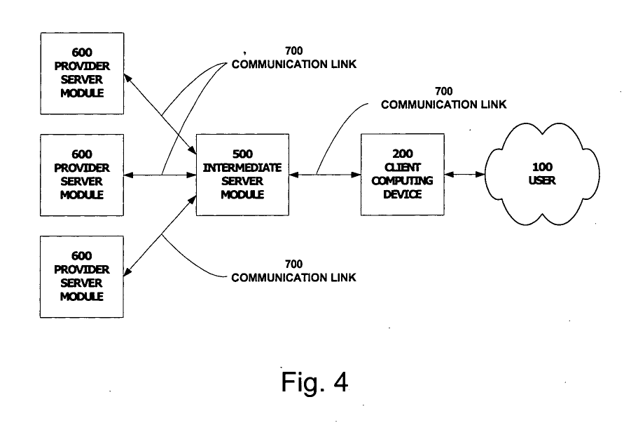

Within a single organization, the infrastructure for active forms shown in FIG. 1 is typical. If multiple organizations interact using active forms, then a more sophisticated infrastructure may be required, such as the one shown in FIG. 4. Each of the provider server modules 600 are assumed to belong to different organizations. Although the intermediate server module 500 and the provider server modules 600 are logically distinct, it may be that multiple modules may be implemented using a single physical computer. Because active forms are moved between organizations, security is more of a problem than when active forms move only within a single organization. To prevent unauthorized access to an active form, encryption may be used on either the communication links 700 that transport the active forms, the forms themselves, or both.

In this example, we assume that the provider server modules 600 are controlled by different organizations that offer complementary products or services. The purpose of such a system is to allow a user the convenience of selecting a complementary set of products or services in a single transaction, rather than requiring separate transaction for each individual provider. By “complementary” products or services, we mean products or services that generally are selected together. For example, the services offered may be air travel, hotel reservations and car rental. However, for each of these services, only one provider is available to the user for any given trip. Typically we would expect that such an arrangement would exist among organizations that have developed a business relationship that include a joint marketing or cross marketing component.

Although the infrastructure may include multiple providers that offer the same product or service, such as air travel, the system can be designed such that there never is direct competition among providers. For example, the specific airline that provides air travel may be selected on the basis of geography: airline A is selected if the trip is within the United States, airline B is selected if the trip is within China, and so forth. It is quite common for airlines to have business relationships such that one partner promotes another partner for travel outside of the region served by the first partner.

Section of a provider by geography as described above is one means to select which one of multiple providers of similar products or services is presented to a user. Other criteria by which such a selection could be made include: the quality that the user desires, the price that the user is willing to pay, the time at which the user places an order, the time at which the product or service is desired, and so forth. For example, it may be that if the user desires a four-star hotel, then Hilton is selected as the provider of choice. However, if the user desires a two-start hotel, then Ramada is selected as the provider of choice.

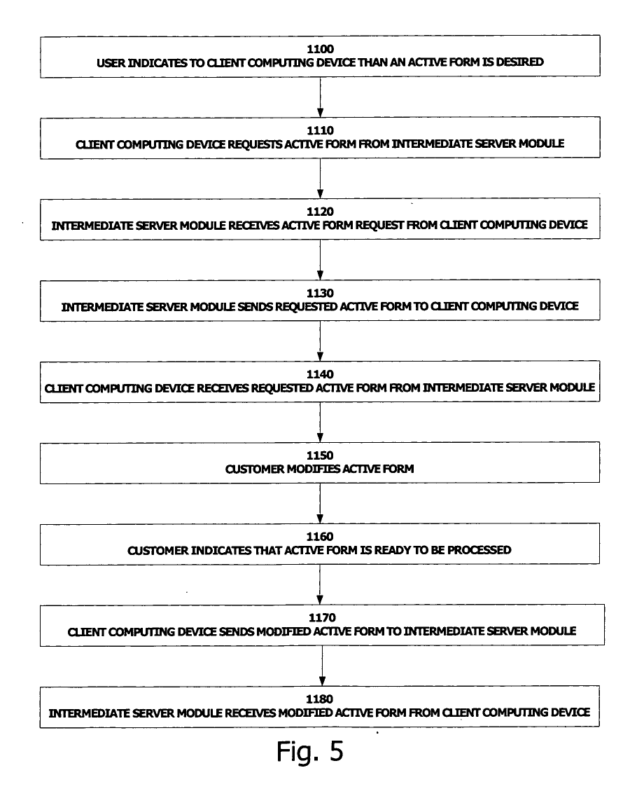

The process of selecting a set of products or services can be divided into four phases: the user request phase, the intermediate request phase, the provider response phase and the confirmation phase. The user request phase, shown in FIG. 5, begins with step 1100 when the user 100 uses his client computing device 200 to request an active form from the intermediate server module 500. The request is sent from the client computing device 200 in step 1110 and is received by the intermediate server module 500 in step 1120. The requested active form is sent from the intermediate server module 500 in step 1130 and is received by the client computing device 200 in step 1140. In step 1150, the user 100 performs the appropriate modifications to the requested active form and indicates that the active form is ready for processing in step 1160. The modified active form is sent by the client computing device 200 in step 1170 and is received by the intermediate server module 500 in step 1180.

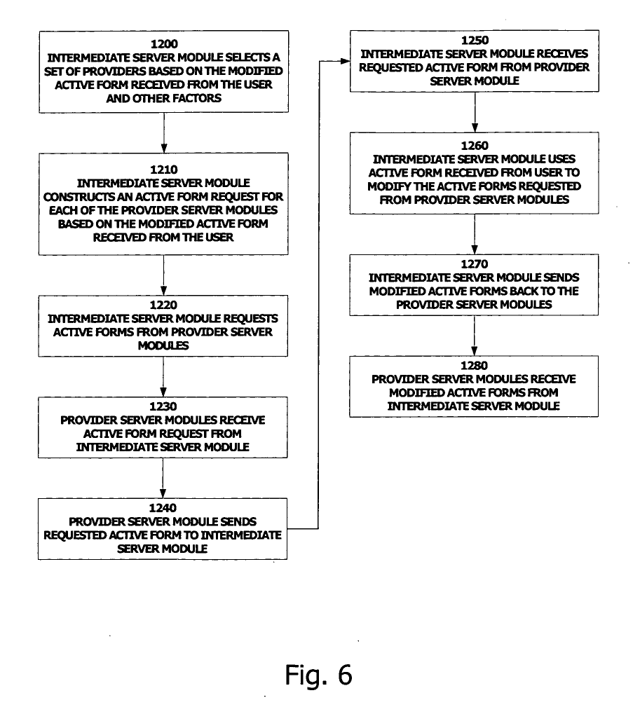

The second phase in the project is the intermediate request phase, as illustrated in FIG. 6. The intermediate server module 500 will request price and availability information for each of the products or services based on the active form received from the user during the user request phase.

In step 1200, the intermediate server module 500 selects a set of providers to be queried based on the active form received from the user 100 during the user request phase as well as other factors. One type of additional factor could be information stored in a database, such as a mapping of hotel quality to hotel providers. Another type of additional factor could be the time at which the user's active form was received.

In step 1210, the intermediate server module 500 constructs an active form request to the provider server modules 600 based on the active form received from the user 100 during the user request phase. The request is sent from the intermediate server module 500 in step 1220 and is received by the provider server modules 600 in step 1230. The requested active form is sent from the provider server modules 600 in step 1240 and is received by the intermediate server module 500 in step 1250.

In step 1260, the intermediate server module 500 uses information from the user's active form to complete all the active forms for price and availability requests received in step 1250. In step 1270, the active forms from the provider server modules 600 are sent back to the provider server modules 600, and the provider server modules 600 receive the active forms from the intermediate server module 500 in step 1280.

Notice that in multi-organization infrastructures, the intermediate server module 500 modifies multiple active forms from the provider server modules 600 based on a single active form from the user 100. This active form replication, shown as step 1260 of FIG. 6, allows the intermediate server module 500 to perform a variety of tasks for the user's benefit in a way that is transparent to the user.

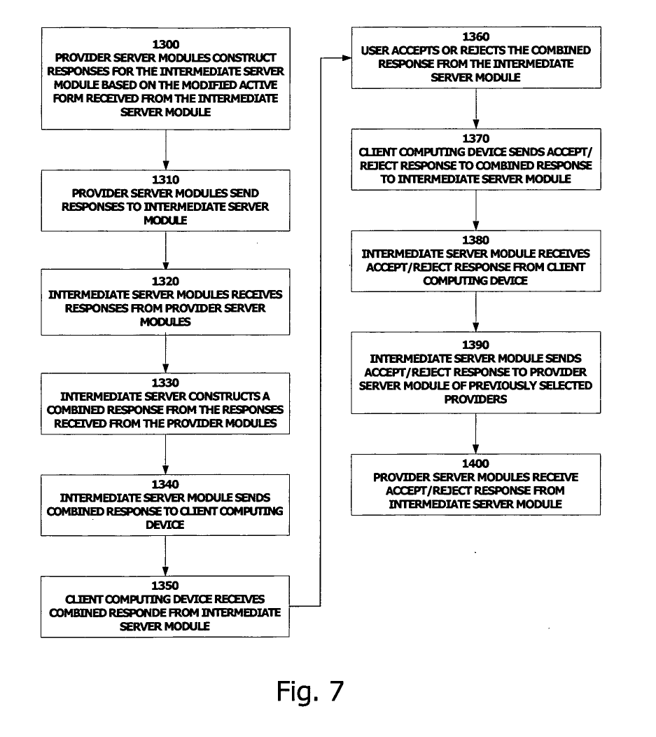

The third phase is the provider response phase is shown in FIG. 7. In step 1300, each provider server module 600 examines the active form request received from the intermediate server module 500, consults its product or service database, and provides a response to intermediate server module 500 in step 1310. The intermediate server module 500 will examine the responses from the provider server modules 600 that are received in step 1320. In step 1330, the intermediate server module 500 constructs a response to the user that combines the various responses received from the provider service modules 600. The intermediate server module 500 sends the combined response in step 1340 and the combined response is received by the client computing device in step 1350. The user accepts or rejects the best offer in step 1360 and the user's response is sent from the client computing device 200 in step 1370 and is received by the intermediate server module in step 1380. In turn, the intermediate server module 500 forwards the user's response to the provider with the best offer, perhaps after reformatting, in step 1390 and the response is received by the provider server module 600 in step 1400.

Notice that in multi-organization infrastructures, the intermediate server module 500 selects the appropriate providers based on a single active form from the user 100 and combines multiple responses from the provider server modules 600 into a single response for the user. This active form combining, shown as step 1330 of FIG. 7, allows the intermediate server module 500 to perform a variety of tasks for the user's benefit in a way that is transparent to the user.

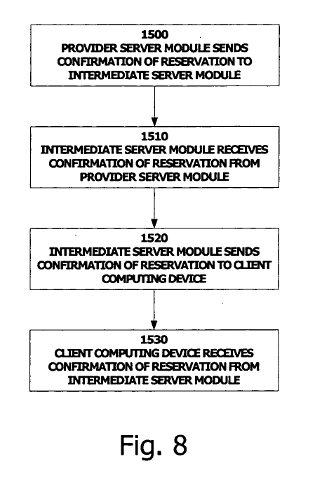

The fourth phase, the provider confirmation phase, is used if the combined response has been accepted by the user. The confirmation phase is shown in FIG. 8. The provider server module 600 sends a confirmation in step 1400 that is received by the intermediate server module 500 in step 1410. In turn, the intermediate server module 500 sends a confirmation in step 1420 that is received by the client computing device 200 in step 1430. As before, the confirmation may be reformatted if necessary, perhaps changing the name on the response from the name of the organization that controls the intermediate server module 500 to the name of the user 100, changing the account number, and so forth.

During user request phase step 1130 of FIG. 5, the requested active form already is available on the intermediate server module 500. However, the active form sent by the intermediate server module 500 to the client computing device 200 can be obtained in several ways. In the simplest case, a pre-defined active form already exists on the intermediate server module 500. Alternatively, the intermediate server module 500 may send reservation requests to one or more provider server modules 600. The provider server modules 600 send active forms to the intermediate server module 500, and the intermediate server module 500 can generate an active form for client computing device using the received active forms. For example, the intermediate server module 500 could combine all of the information fields from all of the received active forms into a single active form that is sent to the user. Alternatively, if the user wishes to use only a specific provider, the intermediate server module 500 can request an active form from a specific provider server module 600, and then simply forward the received active form to the user 100 via the user's client computing device 200.

Providing the user with an active form that combines fields from multiple active forms has two advantages. For the user, it is less work to fill in a single form, particularly since many information fields will exist on all of the active forms from the provider server modules 600. Also, information on the user can be kept by the intermediate server module 500 in a database, and the active form sent to the user can be pre-populated to save the user time. If the user were to request separate active forms from multiple providers, any individual provider may not have information on the user, and will not be able to pre-populate the active form. For the owner of the intermediate server module 500, the advantage of an active form that combines information from several active forms is that the active form sent to the user can have the trademark or service mark of the owner of the intermediate server module 500 and that all of the active forms the user receives from the intermediate server module 500 can have a uniform look and feel.

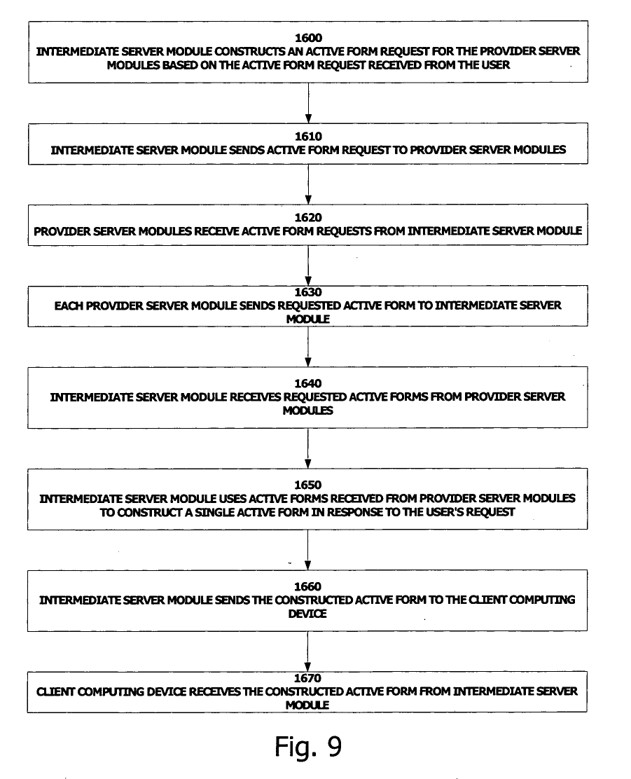

The method of constructing an active form by combining multiple active forms is shown in FIG. 9. In step 1600, the intermediate server module 500 uses the user's active form request to decide which active form to request from each of the provider server modules 600. The intermediate server module 500 sends the request in step 1610 and the provider server modules receive the requests in step 1620. In step 1630 and 1640, the requested active forms are received by the intermediate server module 500 from the provider server modules 600. In step 1650, the intermediate server module 500 constructs an active form based on the contents of the active forms received from the provider server modules 600. Constructing the new active form can be as simple as combining all of the elements of the received active forms and eliminating any duplicate text and fields. A more sophisticated approach would not add anything to the new active form that already is known to the intermediate server module 500 and need not be verified by the user 100. An example of something known that need not be verified is the account number that the intermediate server module 500 has for use with a specific provider; in this case, the account number already is known, but is of no importance to the user. If information is known, but verification by the user is desired, it can be included on the new active form and pre-populated with the known information. An example of this is the user's name. The appropriate text and field would be included in the active form and the name field would be pre-populated with the user's name. Finally, the constructed active form is sent by the intermediate server module 500 and received by the client computing device 200 in steps 1660 and 1670.

Notice that in multi-organization infrastructures, the intermediate server module 500 can combine multiple active forms from the provider server modules 600 into a single active form to be sent to the user 100. This active form combining, shown as step 1650 of FIG. 9, allows the intermediate server module 500 to perform a variety of tasks for the user's benefit in a way that is transparent to the user.

### Intelligent Transport of Active Forms Among Multiple Competing Organizations

In addition to providing the user with a single uniform method to interact with providers of non-competing products and services, the multi-organization infrastructure shown in FIG. 4 also can be used for helping the user to select the best products or services being offered by competing organizations. Consider an example of a user requesting a service or ordering a product, specifically a hotel reservation through a hotel reservation broker. The broker may use active forms both to interact with users that desire hotel reservations and to interact with multiple hotel chains to reserve rooms.

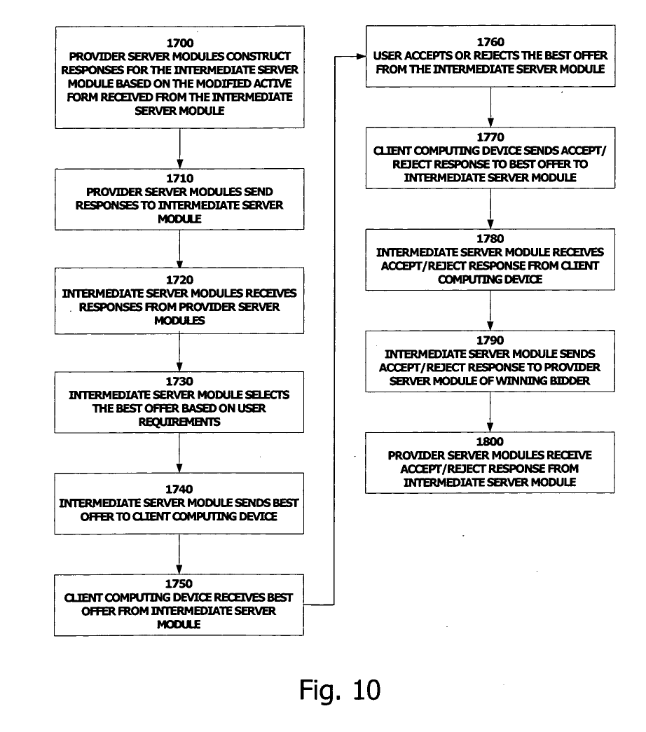

As in the previous example, the process of reserving a hotel room can be divided into four phases: the user request phase, the intermediate request phase, the provider response phase and the confirmation phase. The user request phase, the intermediate request phase and the confirmation phase in this example are identical to the same phases in the previous example; see FIG. 5, FIG. 6 and FIG. 8. However, the provider response phase is different than in the previous example shown in FIG. 7; the new version is shown in FIG. 10.

In step 1700, each provider server module 600 examines the active form request received from the intermediate server module 500, consults its product or service database, and provides a response to intermediate server module 500 in step 1710. The intermediate server module 500 will examine the responses from the provider server modules 600 that are received in step 1720. In step 1730, the intermediate server module selects the response that best meets the user's requirement. The intermediate server module 500 sends the best offer, perhaps after reformatting, in step 1740 and the best offer is received by the client computing device in step 1750. The user accepts or rejects the best offer in step 1760 and the user's response is sent from the client computing device 200 in step 1770 and is received by the intermediate server module in step 1780. In turn, the intermediate server module 500 forwards the user's response to the provider with the best offer, perhaps after reformatting, in step 1790 and the response is received by the provider server module 600 in step 1800.

In step 1750, the broker server computer 500 uses information from the user's active form to complete all the active forms for price and availability requests received in step 1740. In step 1760, the active forms from the provider server computers 600 are sent back to the provider server computers 600, and the provider server computers 600 receive the active forms from the broker server computer 500 in step 1270.

Although we have discussed different methods of interacting with complementary and competing providers of products and services, it is possible for a single system to provide both functionalities simultaneously. Thus, within a single system, some providers will have complementary relationships while other providers will have competitive relationships.

### Distributed Completion of Active Forms by Multiple Users

Another aspect of the invention is methods of processing active forms such that multiple users collaborate to complete an active form. Usually the user of an active form has the ability to indicate that a form is complete. However, if multiple users collaborate to complete an active form, another method is needed to route an active form from one user to another before the active form is returned to the server module that will process the active form.

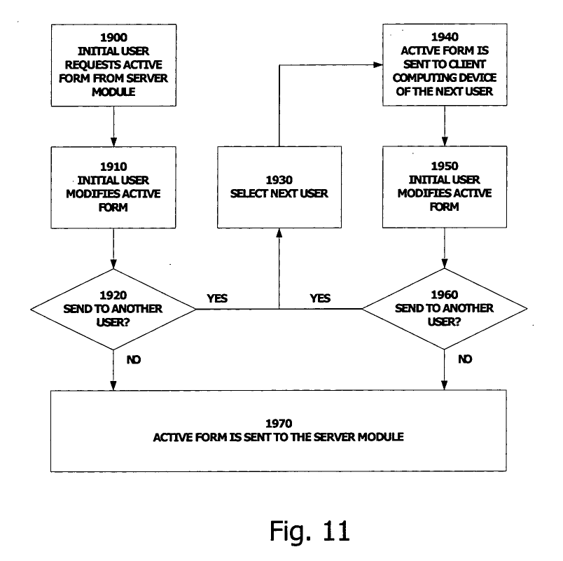

The method of using multiple users to complete an active form is shown in FIG. 11. The initial user requests an active form from a server module in step 1900. In step 1910, the user modifies some of the fields in the active form. In step 1920, the user tells his client computing device to forward the active form to another user. The next user may be chosen in a variety of ways. The current user may explicitly choose the next user by name, or the next user may be chosen on the basis of some characteristic, such as the person who supervises the current user.

In step 1940, the client computing device of the current user sends the partially-completed active form to the client computing device of the next user. In step 1950, the user modifies some of the fields in the active form. In step 1960, the user tells his client computing device to return the form to the server module in step 1970 or to forward the form to the next user and return to step 1930.

There are many ways of making the decision of which user is the next to receive the active form, as performed in step 1930. Each user could select the next user to which the active form is sent. Alternatively, the next user selection could be built into the system. For example, consider the maintenance staff in a hotel and a hotel guest that complains that his television doesn't work. The first user to receive the active form generated as a result of the guest complaint could be part of the guest services staff who verifies that the television doesn't work. If the problem is verified, then the next person to receive the active form may be an electrician who can check that the television is receiving power, has all of the cables correctly connected, and so forth. If the television is indeed the problem, then the next user may be someone who will remove the old television and install a new one.

Although the method shown in FIG. 11 moves the active form directly from the client computing device of one user to the client computing device of another user, the active form could pass through a server module when passed from one user to the next.

### Active Forms on Mobile Computers

Another aspect of the invention is methods of simplifying the use of active forms on mobile computers that may not have access to a communication link at all times.

As described previously, active forms may be moved manually from a server to a client computing device or vice versa. Although a communication link must be available when moving active forms from one computer to another, active forms can be processed on individual computers regardless of whether a communication link is available. This means that a user may complete a form, but if a communication link in unavailable at the time a form is finished, the user must remember to move the form manually at a later time when a communication link is available.

Although a user can complete a form while a communication link is unavailable and later manually transfer the form to another computer when a communication link is available, it would be more convenient for the user if a completed form were transferred automatically as soon as an appropriate communication link were available.

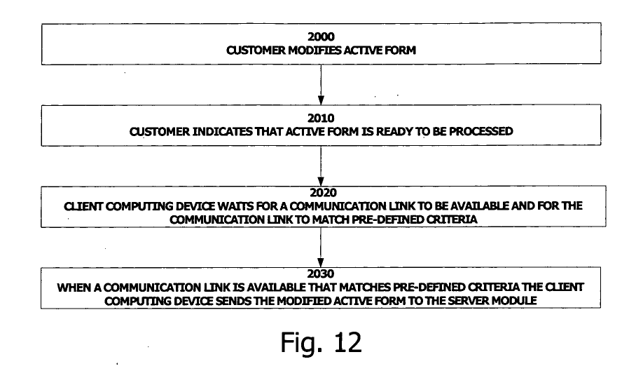

The method of implementing this automatic transfer system for active forms is show in FIG. 12. The user modifies an active form in step 2000 and indicates that the active form is ready to be processed in step 2010. Step 2010 could be accomplished with a button on the form that can be clicked by the user, or a button associated with the application, such as Adobe™ PDF Reader, that indicates that a form has been completed. The completed form is put into a holding area or queue to await transmission.

In step 2020, the computer monitors the transmission link and waits for pre-defined criteria to be satisfied in order to determine whether the communication link is available for the transmission of active forms. In addition to the communication link being active, other possible criteria include the bandwidth of the link, the latency of the link, bandwidth requirements of other applications on the computer, and so forth. Determining information about the communication link could be done passively by monitoring link statistics, or actively by sending message to probe the link.

Once the computer is satisfied that an acceptable communication link is available, the active form is sent to another computer via the communication link in step 2030.

An enhancement to the method described above is to notify the user when an active form has not been submitted by a certain time. The time period could be absolute (e.g., one hour) or relative to some other event. For example, if a hotel reservation is made for a certain date, if the active form still has not been submitted and the current date is within three days of the desired reservation date, the user is notified. Regardless of whether the time period is fixed or relative, the time period may differ for different types of active forms, depending on the perceived urgency of the function provided by the active form.

### Improved Communication and Storage Efficiency for Active Forms

Another aspect of the invention is methods of improving the efficiency of transmitting and storing active forms. By taking advantage of the structure of active forms, the amount of information that must be transmitted or stored may be reduced. Although this discussion will focus on communication of active forms, many of these ideas can be used to reduce the amount of information that must be stored for completed active forms.

One method of reducing the number of transmitted active forms is to maintain copies of active forms on the client computing device. Each active form can have a unique identifier that is specific to that active form and the time at which the active form was modified most recently. Instead of sending the entire active form to the client computing device, the initial communication could contain only the unique identifier and the modification time of the active form. The complete active form is sent only if the server module receives a request from the client computing device because the client computing device does not have a copy of the most recent version of the specific active form.

When a completed active form is sent to a server module, it may not be necessary to return the entire form. For example, if the computer receiving the completed active form knows which active form it has received, it is sufficient to send only the fields of the active form, rather than the entire active form. When the completed active form is sent, rather than sending the entire active form, only the unique identifier and fields of the active form are sent. All of the fields can be sent in a pre-selected order or as field name/field value pairs in an arbitrary order. An advantage of sending field name/field value pairs is that only the fields that have been changed need be transmitted. Given this information, the server module can reconstruct the original active form.

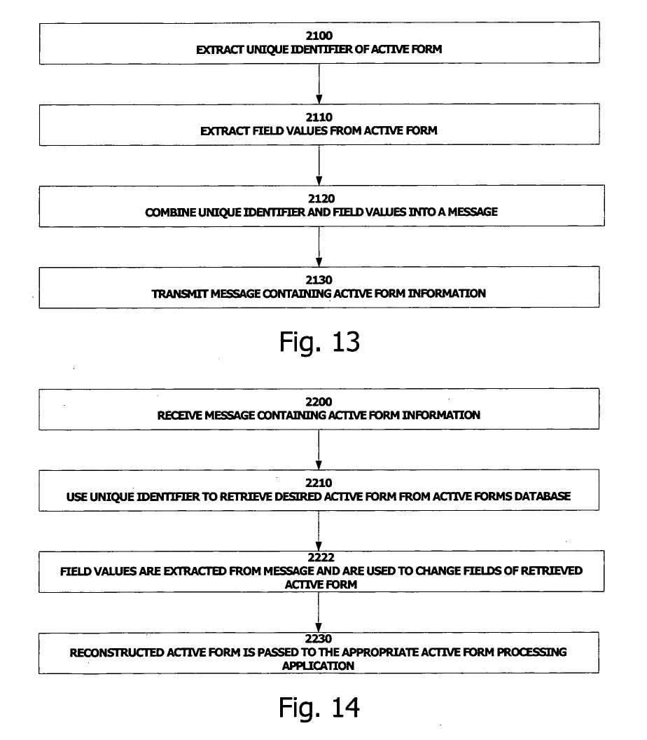

FIG. 13 shows the method of reducing the amount of information that must be transmitted to move an active form from one computer to another. In step 2100, the computer finds and extracts the unique identifier of the active form to be transmitted. In step 2110, the computer finds and extracts the field values from the active form to be transmitted. In step 2120, the unique identifier and field values are combined to form a message and in step 2130, the message is transmitted to another computer.

FIG. 14 shows how the server module reconstructs the active form using the active form's unique identifier. In step 2200, the computer receives a message containing information about an active form. In step 2210, the computer uses the unique identifier to find the appropriate active form. In step 2220, the field values contained in the message are used to change the associated field values of the active form. In step 2230, the reconstructed active form is submitted to an application on the computer that processes this type of active form.

In some cases, the unique identifier of the active form is unnecessary. For example, assume that for any given user, only a single active form can be outstanding at any time. In this case, the server module maintains a database that maps users to the most recently requested active form for each user. When the server module receives an active form, the server module takes the identity of the user and performs a lookup in the database that maps users to outstanding active forms. Once the specific active form has been identified, the server module continues using the method shown in FIG. 14.

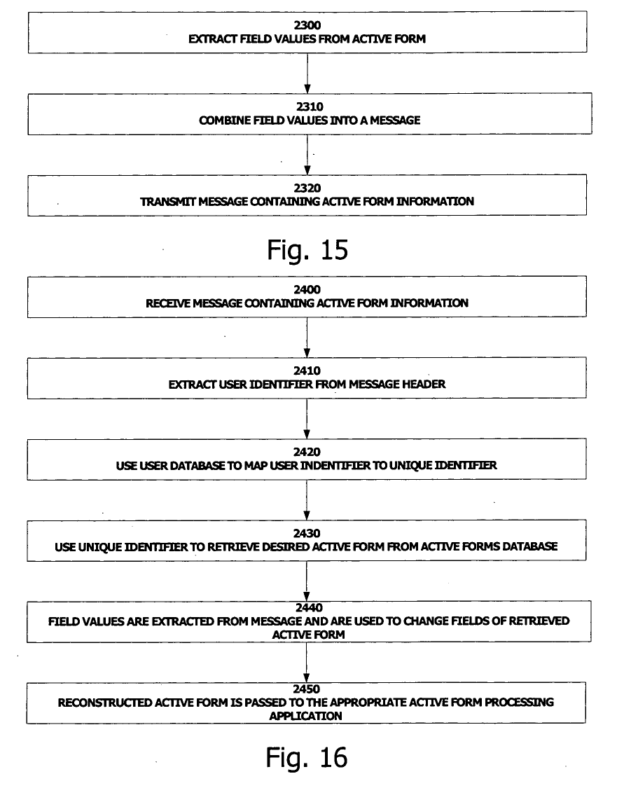

FIG. 15 and FIG. 16 show the method of transporting an active form when only a single active form is available to a user at any given time. The method of FIG. 15 is similar to that of FIG. 13, except that step 2100 of FIG. 13 has been eliminated and consequently, no unique identifier is included in the message generated in step 2320 of FIG. 15.

FIG. 16 shows how the message is processed at the receiver. After the message is received in step 2400, information identifying a specific user is extracted from the message header in step 2410. A user may be identified in a variety of ways, such as using the Ethernet address of the client computing device from which the message was sent. In step 2420, the user identity is mapped to a unique identifier for an active form using a database. The remaining steps 2430, 2440 and 2450 are identical to the steps of the method shown in FIG. 14.

Another method to reduce the amount of information that is transmitted or stored is to bundle multiple active forms together to take advantage of the fact that many fields will be shared among multiple active forms. For example, name and address fields may be included in many active forms. If a bundle of active forms is transmitted, then any field of the same type that contains the same information on all of the active forms in the bundle need be transmitted only once for all active forms in the bundle, rather than once for each active form.

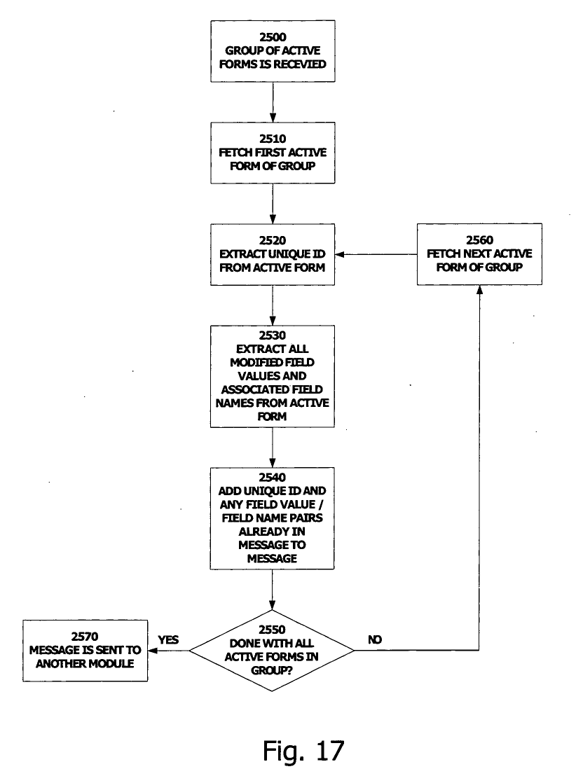

FIG. 17 shows a method of bundling active forms. The set of active forms that are bundled together are selected based on some criteria, such as the set of active forms that must be transmitted within a certain time span. In step 2500, a group of active forms is received and in step 2510 the first active form is fetched. In steps 2520 and 2530, the unique identifier and field value/field name pairs are extracted from the active form. The unique identifier and field value/field name pairs are added to a message in step 2540. Note that if a field value/field name pair already exists in the message, there is no need to add it again, although it may be desirable to verify that the field values are identical for the fields with the same name. Step 2550 determines whether all active forms in the group have been processed. If not, then the next active form of the group is fetched in step 2560 and the loop begins again at step 2520. Otherwise, the completed message is transmitted in step 2570.

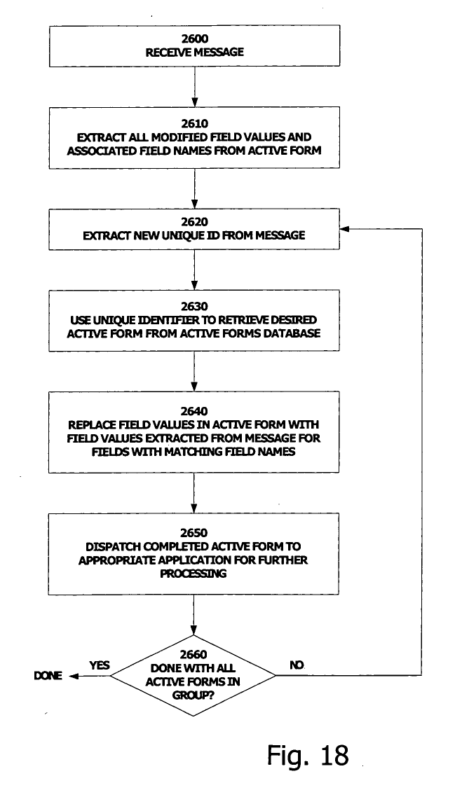

FIG. 18 shows a method of recovering the group of active forms from a message containing information about the group. In step 2600, the message is received and in step 2610, the elements of the message are extracted and saved for later use. In steps 2620 and 2630, a unique identifier that has not previously been processed is extracted from the message and the active form associated with that unique identifier is fetched. In step 2640, field values in the active form are modified using field values from the message when the fields have identical names. The completed active form is dispatched to the appropriate computer application for further processing in step 2650. Step 2660 determines whether the entire message has been processed. If not, then the loop returns to step 2620.

### Populating Active Forms with Information Stored in Databases

Another aspect of the invention is methods of processing active forms using information stored in databases. The information in the database can be used to select from a set of existing forms, to populate some of the user-accessible spaces of a form, to generate a form dynamically, or some combination of these operations.

A database can be populated with information in a variety of ways. For example, a user could access a web site and provide information that would be entered into a database. Alternatively, an active form could be used to enter the same information into a database. A database also may gather information on the user by observing his actions. For example, if a user is staying overnight in a hotel and he adjusts the thermostat in the room to 70 degrees, this information could be stored in a database automatically, so that next time the user visits the hotel, the room thermostat could be set automatically to 70 degrees to make the user more comfortable.

Using a database to select a form or to dynamically create a form can be done only at the original source of the form, such as a server module. However, pre-populating fields, post-populating fields or changing fields of an active form can be done at any computer. Pre-populating means modifying previously unmodified fields of an active form before the active form is modified by the user. Post-populating means modifying previously unmodified fields of an active form after the active form is modified by the user. Changing means modifying an already modified field.

Pre-populating fields is valuable because it saves the user's time by reducing the amount of typing that he must do. Typically pre-populating fields is done on a server module before the active form is sent to the client computing device of the user. However, an alternative is to have the client computing device pre-populate the active form when it is received. This approach has the advantage of associating the user's information with the user's client computing device, so that active forms can be pre-populated regardless of where the active forms originate.

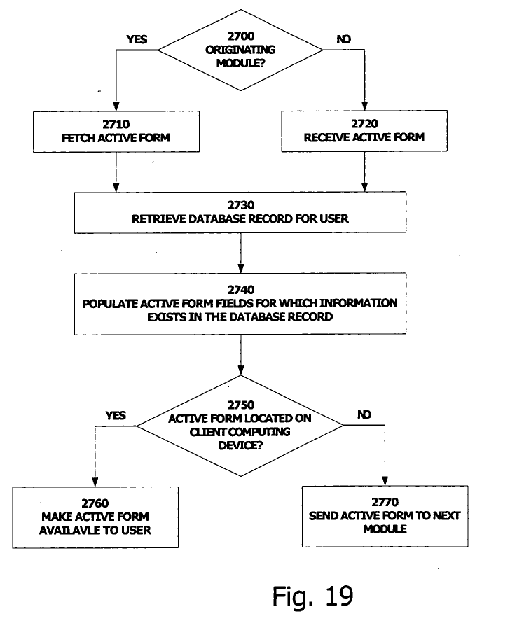

FIG. 19 shows the method of pre-populating an active form. In step 2700, a decision is made whether the computer is the originator of the active form or is handling an active form received from another computer. If it is the originator, then the active form is fetched from a database of active forms in step 2710; otherwise, an active form is selected that was received from another computer in step 2720. In step 2730, information about the user who is to receive the active form is retrieved from a database. The information retrieved from the database is used in step 2740 to pre-populate some or all of the active form fields for which appropriate information about the user exists. Step 2750 determines what is done with the modified active form. If the active form is at the user's client computing device, then the active form is dispatched to the appropriate computer application in step 2760. Otherwise, the active form is sent to the next computer along the path to the user in step 2770.

Post-populating fields is valuable because it saves the user's time, but also has the advantages of improving security and reducing the amount of data that is transmitted. Consider the multiple-organization infrastructure shown in FIG. 4. Assume that the user has stored his credit card information on intermediate server module 500. When the user 100 completes the active form, he does not fill out the credit card information on the form if he wants to use a credit card that already has been stored in the database of the intermediate server module 500. When the completed form is returned to the intermediate server module 500, if the credit card information has not been added by the user 100, then the intermediate server module 500 uses the user's credit card information that is stored in a database to post-populate the credit card fields of the active form. If the user 100 has modified the credit card fields of the active form, then these fields are not modified by the intermediate server module 500.

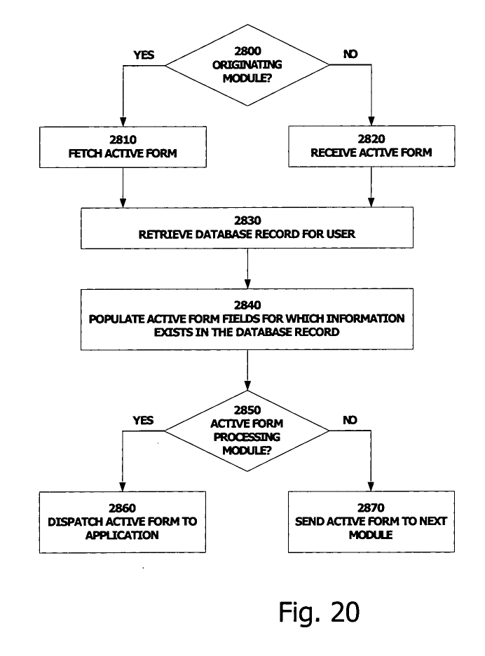

FIG. 20 shows the method for post-populating an active form and the method is similar to the method shown in FIG. 19 for pre-populating an active form.

In step 2800, a decision is made whether the computer is the originator of the active form or is handling an active form received from another computer. If it is the originator, then the active form is fetched from a database of active forms in step 2810; otherwise, an active form is selected that was received from another computer in step 2820. In step 2830, information about the user who is to receive the active form is retrieved from a database. The information retrieved from the database is used in step 2840 to pre-populate some or all of the active form fields for which appropriate information about the user exists. Step 2850 determines what is done with the modified active form. If the active form is at the computer that will process the active form, then the active form is dispatched to the appropriate computer application in step 2860. Otherwise, the active form is sent to the next computer along the path to the user in step 2870.

Changing an active form is similar to pre-populating and post-populating, the difference being that instead of modifying an active form field that has a null value, changing modifies an active form field that already has been modified previously. Changing active form fields is useful in a multi-organization infrastructure, such as in FIG. 4. Consider the case in which a user 100 has an account number that is specific to the hotel reservation broker and that the hotel reservation broker has account numbers that are specific to each hotel provider. For an active form sent to the user 100, the intermediate server module 500 will insert the hotel broker's account number into the account number field of the active form, even if the provider server module 600 already has pre-populated the account number field of the active form. For an active form sent from the user 100, the intermediate server module 500 will insert the hotel broker's account number into the account number field of the active form, even if the active form already has an account number field of the active form. If an active form field always will be changed by the intermediate server module 500, this field can be removed from the active form that is sent initially from the intermediate server module 500 to the user 100 because any input from the user 100 will be overwritten.

### Updating Information in Databases by Reading Information in Active Forms

Another aspect of the invention is a method for updating information in databases using the information contained in active forms.

Active forms completed by the user for reasons other than updating the database also can be used to update the database. For example, let us say that a woman marries and begins using the last name of her husband rather than her maiden name. The woman may fill out an active form for a hotel reservation and notice that the area on the active form for her last name has been pre-populated with her maiden name rather than her married name. She changes the last name on the active form to her married name and returns the active form to complete her hotel reservation. As the active form is processed by a computer that has pre-populated the active form with the last name of the user, the computer examines the active form to see whether any of the pre-populated information has been changed by the user. If so, then the field value in the active form is used to update the user information that is stored in the database. Thus, the next time that an active form is pre-populated using this database, the correct last name will be inserted.

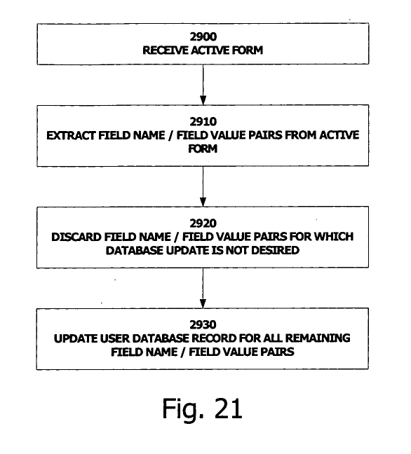

A method for automatically updating databases using the information contained in active forms is shown in FIG. 21. An active form is received in step 2900. In step 2910, all of the field name/field value pairs are extracted from the form. In step 2920, field name/field value pairs for which database update is not desired are discarded. The filtering performed in step 2930 prevents the database from being filled with information that is not useful for pre-populating or post-populating active forms because they are likely to change, such as the date field of the active form. In step 2940, the remaining field name/field value pairs are used to update the database.

What is claimed is:

1. A method of processing active forms, comprising the steps:
reading input information from an input active form;
producing output information based on said input information;
writing said output information to a plurality of output active forms;
determining the destinations of said output active forms; and
transmitting said output active forms to a plurality of destinations.

2. The method of claim 1, wherein said output active forms are for a function from a group consisting of:
requesting a reservation for a service;
requesting the availability of a service;
requesting the availability of a good;
requesting the price of a service;
requesting the price of a good;
purchasing a service, and
purchasing a good.

3. The method of claim 1, wherein the step of producing said output information based on said input information is implemented using at least one database operation.

4. The method of claim 3, wherein the step of determining the destinations of said output active forms is performed using information selected from a group consisting of:
type of desired service;
type of desired good;
preferred provider of a service;
preferred provider of a good;
location at which a service is to be provided;
location to which a good is to be delivered;
time at which a service is to be provided;
time at which a good is to be delivered;
desired price of a service;
desired price of a good;
desired quality of the service;
desired quality of the good; and
time at which a purchase request is made.

5. A method of processing active forms, comprising the steps:
determining that an active form is ready for transmission to a server module;
storing on a client computing device said active form that is ready to be transmitted;
monitoring a communication link, and;
transmitting said active form when the communication link characteristics fall into the range of at least one pre-specified criteria.

6. The method of claim 5, wherein the step of determining that an active form is ready for transmission to a server module is performed by providing a button on said active form that can be clicked by a user when said active form is ready for transmission.

7. The method of claim 5, wherein the step of determining that an active form is ready for transmission to a server module is performed by providing a button in the application program that is used to modify said active form.

8. The method of claim 5, wherein the step of monitoring a communication link includes notifying the user if said active form has not been transmitted by a pre-determined time.

9. The method of claim 8, wherein said pre-determined time is set based on the type of active form.

10. A method of processing active forms, comprising the steps:
finding the user-modifiable fields of an active form;
performing a database search to retrieve relevant data, if any, for each user-modifiable field, and;
writing a value to each user-modifiable field for which relevant data is found in the database.

11. The method of claim 10 performed after a user has modified at least one user-modifiable field of the active form.

12. The method of claim 10 performed by an intermediate server module.

13. The method of claim 10 performed by a client computing device.
